(19) United States
(12) Patent Application Publication
(10) Pub. No.: US 2007/0284050 A1
(43) Pub. Date: Dec. 13, 2007

(54) Method and apparatus for hermetically sealing a zipper into a reclosable package

(75) Inventors: Lars Wihlborg, Startford, CT (US); Clifton Howell, Buford, GA (US)

Correspondence Address: DAY PITNEY LLP;ACCOUNT: ILLINOIS TOOL WORKS INC., 7 TIMES SQUARE, NEW YORK, NY, 10036-7311, US

(73) Assignee: ILLINOIS TOOL WORKS INC.

(21) Appl. No.: 11/449,999

(22) Filed: Jun. 9, 2006

(51) Int. Cl. B30B 15/34

(52) U.S. Cl. 156/583.1; 156/583.3

(57) ABSTRACT

A method and apparatus is disclosed which include a pair of opposed seal bars for the manufacture of reclosable packages. The method and apparatus are particularly adaptable to form fill seal manufacture of reclosable packages. At least one of the opposed seal bars includes a rubberized or otherwise deformable sealing surface. This allows a hermetic seal to be formed across an abrupt transition of thickness of material between the opposed seal bars, such as when a zipper ends adjacent to a side seal in a reclosable bag.

### BACKGROUND OF THE INVENTION

1. Field of the Invention

The present invention relates to a method and apparatus for hermetically sealing a zipper into a reclosable package. In particular, the present invention relates to a pair of seal bars with a first seal bar which has a rubberized and deformable sealing surface and a second seal bar made of metal and patterned to reduce the surface area. This is typically used in combination with a peel seal and is particularly useful for hermetically sealing a flanged zipper into a package on a form fill seal machine.

2. Description of the Prior Art

In the prior art, methods and apparatus for the manufacture of reclosable packages are well developed and satisfactory for their purposes. Form fill seal methods and apparatus are particularly suitable for the manufacture of reclosable packages.

Many applications require that the seals in a reclosable package be hermetic. However, when a flanged zipper is used, both the seal of the zipper to the package and the seal of the package walls to each other (particularly immediately adjacent to the cut ends of the zipper) must be hermetic. In particular, this may occur when a zipper is applied transversely to a film, before the zipper film is introduced to a form fill seal apparatus. In the form fill seal apparatus, the film is folded around the zipper ends and the film edges are sealed together in a side seam. As the zipper may be shorter than the front panel of the package, this often leaves a small gap between the side folds of the film and the zipper ends. The subsequently required hermetic sealing involves two different thicknesses of material, as well as the abrupt transition therebetween. This can be difficult using prior art seal bars, wherein both seal bars of an opposed pair are made of metal with interlocking teeth, using conducted heat to activate the sealant layers.

### OBJECTS AND SUMMARY OF THE INVENTION

It is therefore an object of the present invention to provide seal bars and a method of use thereof, particularly for form fill seal or similar apparatus, for the manufacture of reclosable packages, wherein the seal bars provide hermetic seals along a seal line with various thicknesses of material.

It is therefore a further object of the present invention to provide seal bars and a method of use thereof, particularly for form fill seal or similar apparatus, for the manufacture of reclosable packages, wherein the seal bars can provide hermetic seals along a seal line with abrupt transitions in thicknesses of material.

It is therefore a still further object of the present invention to provide seal bars and a method of use thereof, particularly for form fill seal or similar apparatus, which are easily adaptable into existing apparatus without substantial modification.

These and other objects are attained by providing a pair of opposed seal bars wherein a first seal bar has a rubberized and deformable sealing surface so as to maintain contact with the web material notwithstanding different thicknesses and possible abrupt transitions therebetween and wherein a second seal bar is metal. Typically, the width of the jaw face of the first and second seal bars is reduced and the sealing surface has a geometry to make a seal line in a controlled pattern. This is typically used in combination with a peel seal to improve the quality of the seal. The peel seal and the flange-to-package seal may be co-extensive across the length of the package or may be co-extensive only near the side seals.

### BRIEF DESCRIPTION OF THE DRAWINGS

Further objects and advantages of the invention will become apparent from the following description and from the accompanying drawings, wherein:

FIG. 1 is a perspective view of the pair of opposed seal bars of the present invention.

FIG. 2 is a plan view of a first zipper which can be used in the reclosable package manufactured by the pair of seal bars of the present invention.

FIG. 3 is a plan view of a second zipper which can be used in the reclosable package manufactured by the pair of opposed seal bars of the present invention.

FIG. 4 is a plan view of a section of a first reclosable bag, including the zipper of FIG. 2, manufactured by the pair of opposed seal bars of the present invention.

FIG. 5 is a plan view of a section of a second reclosable bag, including the zipper of FIG. 3, manufactured by the pair of opposed seal bars of the present invention.

FIG. 6 is a detailed portion of FIG. 5.

FIG. 7 is a cross-sectional view along plane 7-7 of FIG. 6, showing the pair of opposed seal bars of the present invention forming the reclosable package of FIGS. 4 and 5.

### DETAILED DESCRIPTION OF THE PREFERRED EMBODIMENT

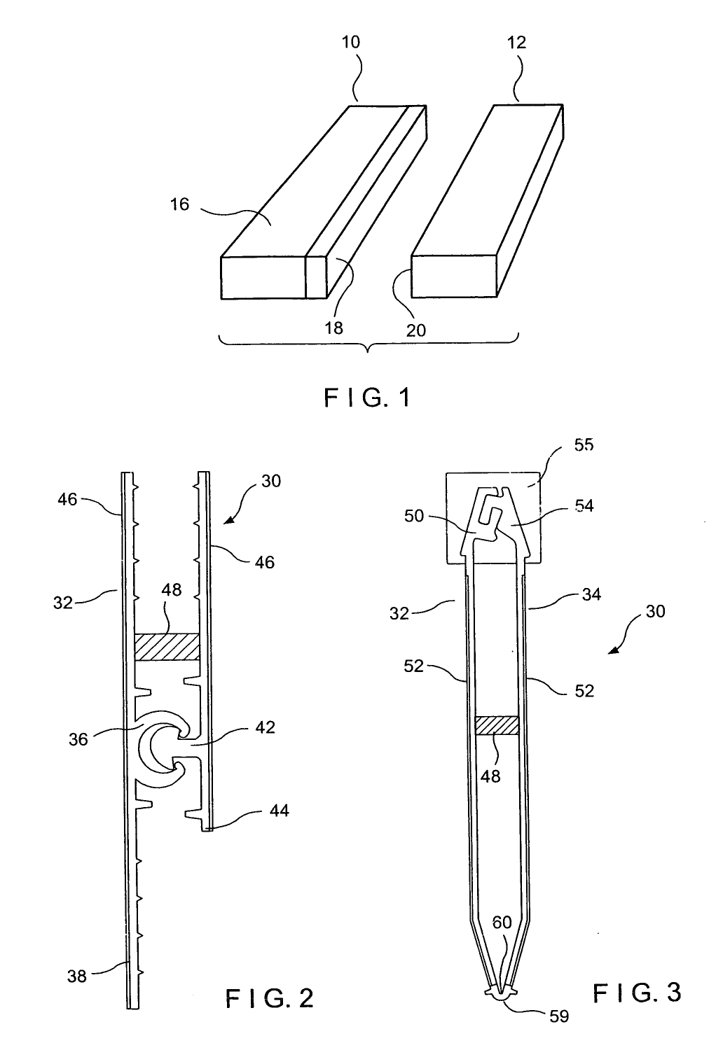

Referring now to the drawings in detail wherein like numerals indicate like elements throughout the several views, one sees that FIG. 1 is a perspective view of the first opposed seal bar 10 and the second opposed seal bar 12 of the present invention. First and second seal bars 10, 12 are particularly adaptable to form fill seal methods and apparatus, but may be applied to similar methods and apparatus. First opposed seal bar 10 includes metal heating and support portion 16 and rubberized sealing surface 18. Second opposed seal bar 12 is a unitary metal piece which performs the heating and supporting functions. Second opposed seal bar 12 further includes sealing surface 20. Sealing surface 20 typically has no teeth and is provided in a smooth configuration. However, alternative embodiments may include a patterned sealing surface 20 or a sealing surface 20 with teeth. Additionally, first and second opposed seal bars 10, 12 and sealing surfaces 18, 20 have the necessary shapes for forming any non-linear seal lines, as required.

At least one of opposed seal bars 10, 12 is reciprocating so that opposed sealing surfaces 18, 20 close over web and zipper profiles, such as shown in FIG. 7, so as to form seals therebetween.

FIG. 2 illustrates a first embodiment of zipper 30 which can be used in association with the present invention. Zipper 30 of FIG. 2 includes first profile 32 and second profile 34. First profile 32 includes female interlocking element 36, first product side flange 38 and first consumer side flange 40. Likewise, second profile 34 includes male interlocking element 42, second product side flange of reduced size 44 and second consumer side flange 46. Male and female interlocking elements 36, 42 are shown in an interlocked configuration with each other. Peel seal 48 is hermetically first and second consumer side flanges 40, 46 immediately above interlocking elements 36, 42.

FIG. 3 illustrates a second embodiment of zipper 30 which can be used in conjunction with the present invention. Zipper 30 of FIG. 2 includes first profile 32 and second profile 34. First profile 32 includes first interlocking element 50 and first flange 52. Second profile 32 includes second interlocking element 54 and second flange 56. First and second flanges 52, 56 may be formed of a single sheet of material with fold 58 therebetween, with scored line of weakness 60 formed in fold 58. Peel seal 48 is formed between the central areas of first and second flanges 52, 56. Slider 55 is mounted on first and second interlocking elements 50, 54 and operates in the conventional manner by separating first and second interlocking elements 50, 54 when moved in a first direction and by interlocking first and second interlocking elements 50, 54 when moved in a second direction.

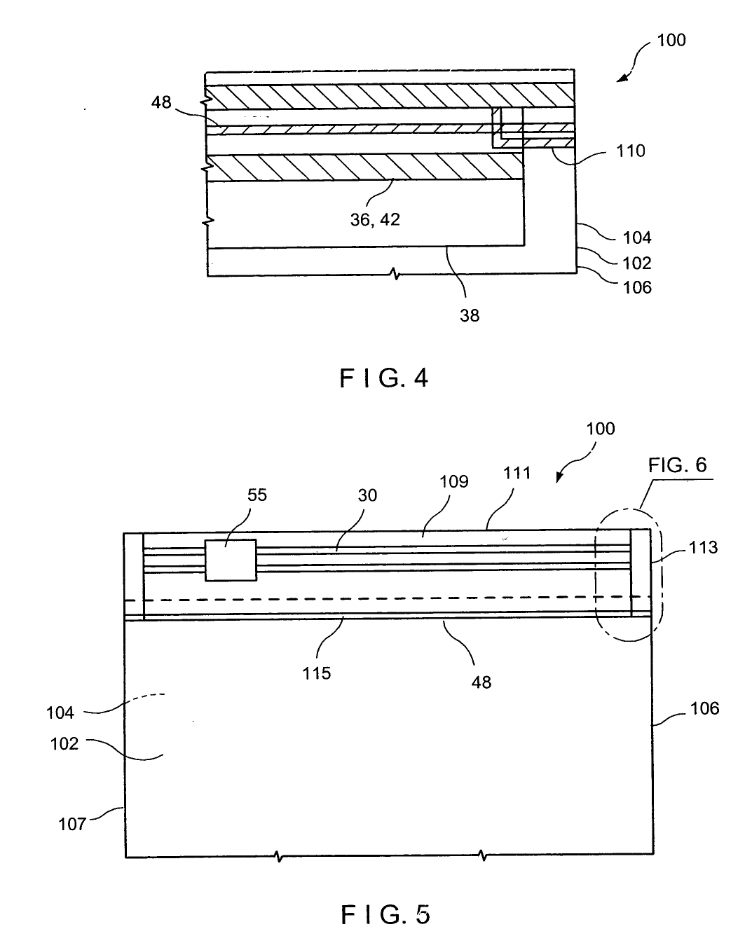

FIG. 4 is a plan view of section of a first reclosable package 100 manufactured by the present invention. Reclosable package 100 includes front and rear co-extensive web panels 102, 104 which are typically sealed together along the bottom edge and both side edges. Single side seal 106 is illustrated in FIG. 4. The zipper 30 illustrated in FIG. 2 is incorporated in FIG. 4 so that first product side flange 38, interlocking elements 36, 42 and peal seal 48 are illustrated. Similarly, seal line 108 between first consumer side flange and front panel of web 102 is illustrated, and is above peel seal 48. It is shown by exaggeration that zipper 30 does not reach side seal 106 and is not included therein. This requires seal extension 110 extending from top seal 108 to side seal 106, crossing over peel seal 48 immediately adjacent to side seal 106 in order to maintain the integrity of the package 100. That zipper 30 does not reach side seal 106 further causes an abrupt transition in the thickness of the combined material between the portion of package including zipper 30 and the side seal 106. If prior art seal bars with opposed metal sealing surfaces were used, this transition in the thickness of the combined material could cause a deficiency or lack of hermetic sealing in seal extension 110 (requiring a corresponding non-linear shape of seal bars 10, 12). However, as will be explained in further detail with respect to FIG. 7, the deformability of rubberized sealing surface 18 allows an improved quality of seal to be formed in this respect.

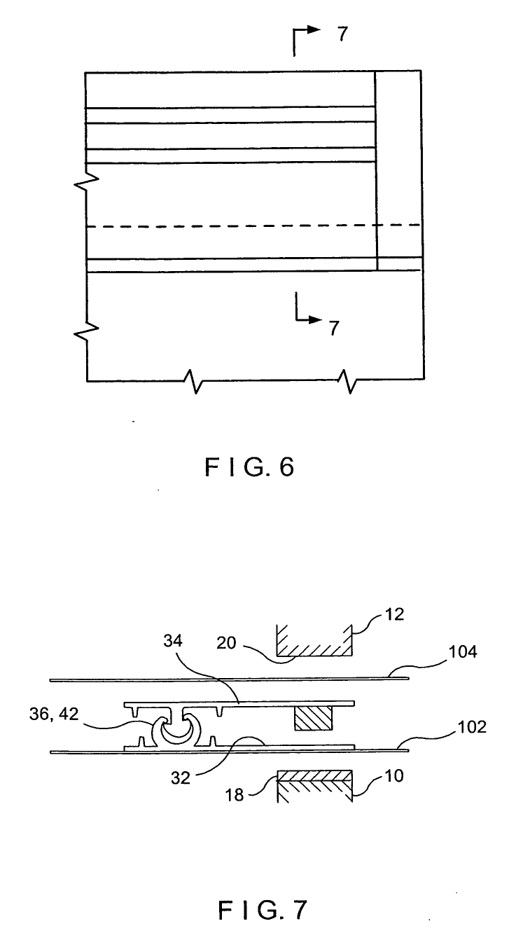

Similarly, FIG. 5 is a plan view of section of a second reclosable package 100 manufactured by the present invention, including zipper 30 of FIG. 3. Reclosable package 100 includes front and rear co-extensive web panels 102, 104 which are typically sealed together along the bottom edge and both side edges. Side seals 106, 107 are illustrated in FIG. 5. Additionally, top edges are sealed together along top seal 109, and perforated lines 111 are formed immediately downwardly adjacent therefrom in front and rear panels of web 102, 104 thereby forming a tear-away header 113. Seal line 115 is formed between front web panel 12 and first profile 32 of zipper 30 of FIG. 3 and is co-extensive with peel seal 48. Seal extensions 117, 119 are formed at the ends of seal 115, joining side seals 106, 108, respectively, to seal 115 (see FIG. 6).

For the manufacturing of reclosable packages 100 of FIGS. 4 and 5, typically the flanges of one of the profiles 32, 34 of zipper 30 is sealed transversely to the web or film before the film is introduced to a form fill seal machine (such as a vertical form fill seal machine). The film is then folded around the zipper and the film edges are sealed together as a side seam. This may result in a small gap between the side folds of the film and the zipper ends. Seal bars 10, 12, in combination with peel seal 48, are used to seal this small gap.

In this regard, as shown in FIG. 7, a cross-sectional view of FIG. 6, seal bars 10, 12 engage front and rear web panels 102, 104 against zipper 30. One of the profiles 32, 34 of zipper 30 is typically previously transversely sealed to the respective one of web panels 102, 104 (that is, prior to introduction to the form fill seal apparatus and prior to the use of seal bars 10, 12). The deformability of rubberized sealing surface 18 of first seal bar allows the seal bars 10, 12 to maintain continuous contact with front and rear web panels 102, 104 throughout the transition in thicknesses of the material between seal bars 10, 12 caused by zipper 30 terminating adjacent to the side seals. This continuous contact, along with peel seal 48 being between the seal bars 10, 12 immediately adjacent to the side seals, results in improved quality in the hermetic seal between the remaining profile and the respective web panel.

Various alternatives of this invention could include one heated seal bar and one ambient seal bar; zone heated seal bars; different geometries to accommodate different zipper configurations; two seal bars with rubberized sealing surfaces; and teeth or similar patterns added to one or both seal bars.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A pair of opposed seal bars including a first seal bar and a second seal bar, wherein the first seal bar includes a deformable sealing surface.

2. The pair of opposed seal bars of claim 1 wherein the deformable sealing surface is rubberized.

3. The pair of opposed seal bars of claim 2 wherein the second seal bar includes a metal, sealing surface.

4. The pair of opposed seal bars of claim 1 wherein at least one of the first and second seal bars is heated.

5. The pair of opposed seal bars of claim 1 wherein the first and second seal bars are heated.

6. The pair of opposed seal bars of claim 1 wherein the first and second seal bars have a reciprocating relationship with respect to each other.

7. The pair of opposed seal bars of claim 1 wherein the first and second seal bars have a non-linear shape.

8. The pair of opposed seal bars of claim 1 wherein the first and second seal bars have a linear shape.

9. The pair of opposed seal bars of claim 1 wherein the deformable sealing surface is adapted to accommodate a transition in thickness from a side seal between first and second sheets of web to a zipper engaged between the first and second sheets of web adjacent to the side seal.

10. The pair of opposed seal bars of claim 1 wherein the deformable sealing surface is adapted to accommodate a transition in thickness from a side seal between first and second sheets of web to a zipper engaged between the first and second sheets of web adjacent to the side seal, wherein the zipper includes a first and second profile with a peel seal therebetween.

11. A pair of opposed seal bars including a first seal bar and a second seal bar, wherein the first seal bar includes a deformable sealing surface; and further including first and second sheets of web with a zipper between the pair of opposed seal bars.

12. The pair of opposed seal bars of claim 11 wherein the deformable sealing surface is rubberized.

13. The pair of opposed seal bars of claim 12 wherein the second seal bar includes a metal sealing surface.

14. The pair of opposed seal bars of claim 11 wherein at least one of the first and second seal bars is heated.

15. The pair of opposed seal bars of claim 11 wherein the first and second seal bars are heated.

16. The pair of opposed seal bars of claim 11 wherein the first and second seal bars have a reciprocating relationship with respect to each other.

17. The pair of opposed seal bars of claim 11 wherein the first and second seal bars have a non-linear shape.

18. The pair of opposed seal bars of claim 11 wherein the first and second seal bars have a linear shape.

19. The pair of opposed seal bars of claim 11 wherein the deformable sealing surface is adapted to accommodate a transition in thickness from a side seal between the first and second sheets of web to the zipper engaged between the first and second sheets of web adjacent to the side seal.

20. The pair of opposed seal bars of claim 11 wherein the deformable sealing surface is adapted to accommodate a transition in thickness from a side seal between the first and second sheets of web to the zipper engaged between the first and second sheets of web adjacent to the side seal, wherein the zipper includes a first and second profile with a peel seal therebetween.
